(19) United States
(12) Patent Application Publication
(10) Pub. No.: US 2015/0066742 A1
(43) Pub. Date: Mar. 5, 2015

(54) PAYMENT APPLICATION WITH MERCHANT PHYSICAL LOCATION PERSONALIZATION

(71) Applicants: Geoffrey W. Chatterton, Santa Clara, CA (US); David Good, Sunnyvale, CA (US); Ramaneek Khanna, Saratoga, CA (US); Tim Nichols, Los Altos, CA (US)

(72) Inventors: Geoffrey W. Chatterton, Santa Clara, CA (US); David Good, Sunnyvale, CA (US); Ramaneek Khanna, Saratoga, CA (US); Tim Nichols, Los Altos, CA (US)

(21) Appl. No.: 14/015,010

(22) Filed: Aug. 30, 2013

(51) Int. Cl. G06Q 20/32; G06Q 20/10

(52) U.S. Cl. CPC G06Q 20/322; G06Q 20/10
USPC 705/39

(57) ABSTRACT

Systems and methods for providing a payment application personalized for a merchant physical location include receiving a first customer location from a first customer device that is running a payment application. A first merchant physical location is then determined to be associated with the first customer location and, in response, first merchant physical location personalization information is retrieved. The first merchant physical location personalization information is then provided for display as a user interface on at least one personalized merchant physical location screen that is provided on the first customer device using the payment application. The at least one personalized merchant physical location screen is configured to send an instruction to the payment application provider device to make a payment from a first customer account associated with the first customer to a first merchant account associated with the first merchant physical location.

### BACKGROUND OF THE INVENTION

The present invention generally relates to online and/or mobile payments and more particularly to a payment application for making online/mobile payments that may be personalized for any of a plurality of merchant physical locations.

### RELATED ART

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PAYPAL, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Some payment applications such as, for example, the PAYPAL mobile payment application available from PAYPAL, Inc. of San Jose, Calif., provide customers with the ability to make payments to merchants at their corresponding merchant physical locations. For example, a customer may enter a merchant physical location and select products and/or services for purchase, and may then use the payment application on their mobile device in order to make a payment for the selected products and/or services. In the course of making a payment to a merchant in such a manner, the customer typically searches for and finds the merchant using the payment application, followed by being provided a payment screen on the payment application that, other than including the merchant name in a payee section of the payment screen, includes no other indications that the customer is dealing with the merchant from whom they are making the purchase. While such mobile payments systems provide the basic ability to make a mobile payment to a merchant, they lack any merchant specific features that would allow the customer to quickly confirm they are dealing with that merchant, as well as features that may drive further purchases from that merchant.

Thus, there is a need for an improved mobile payment system.

### BRIEF DESCRIPTION OF THE FIGURES

FIG. 1 is a flow chart illustrating an embodiment of a method for providing a payment application that is personalized for a merchant physical location;

FIG. 2 is a screen shot illustrating an embodiment of a merchant physical location personalization information provision screen;

FIG. 3a is a screen shot illustrating an embodiment of a home screen of a payment application provided on a customer device;

FIG. 3b is a screen shot illustrating an embodiment of a merchant detection screen of a payment application provided on a customer device;

FIG. 3c is a screen shot illustrating an embodiment of a personalized merchant physical location screen of a payment application provided on a customer device;

FIG. 3d is a screen shot illustrating an embodiment of a personalized merchant payment screen of a payment application provided on a customer device

FIG. 4 is a screen shot illustrating an embodiment of a personalized merchant physical location screen of a payment application provided on a customer device;

FIG. 5 is a schematic view illustrating an embodiment of a networked system;

FIG. 6 is a perspective view illustrating an embodiment of a customer device;

FIG. 7 is a schematic view illustrating an embodiment of a computer system; and

FIG. 8 is a schematic view illustrating an embodiment of a payment application provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION OF THE INVENTION

The present disclosure provides systems and methods for providing a payment application that may be personalized for any of a plurality of different merchants when a customer uses that payment application at one or more merchant physical locations of those merchants. A payment application provider such as, for example, a payment service provider, may provide a payment application that enables a customer to make a payment to a merchant by entering and/or confirming payment details on their customer device such that the payment application provider or payment service provider causes funds to be transferred from a customer account of the customer to a merchant account of the merchant. The payment application provider may receive merchant physical location personalization information from the merchant by, for example, providing a payment application template that the merchant may modify, adjust, and/or otherwise customize with the merchant physical location personalization information. The payment application provider may then receive a customer location from a customer device of a customer (e.g., in response to the customer launching the payment application on their customer device), and if that customer location matches a merchant physical location for which merchant physical location personalization information has been provided, the payment application provider may then provide the merchant physical location personalization information as part of one or more user interfaces on the payment application. Such systems and methods allow participating merchants to “brand” the payment application, and may operate to make customers more comfortable with making mobile payments while offloading the provision of the merchant specific payment application to the payment application provider.

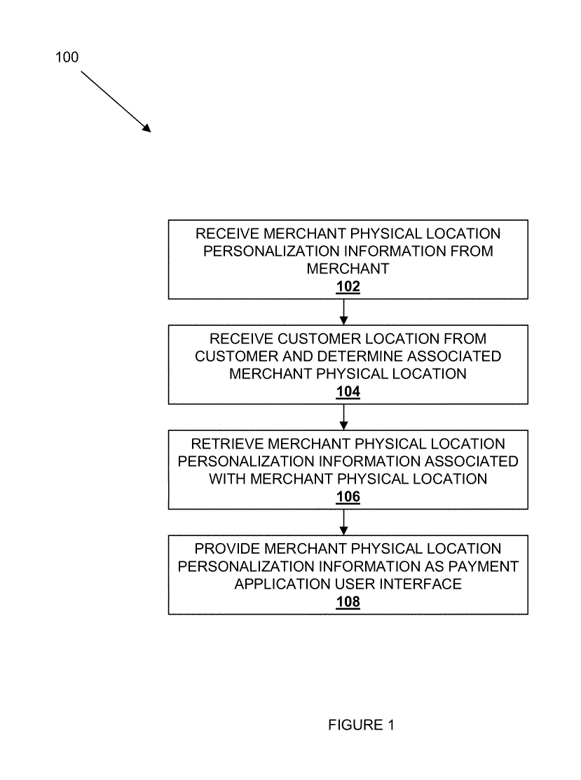

Referring now to FIG. 1, a method 100 for providing a payment application personalized for a merchant physical location is illustrated. In the embodiments discussed below, the payment application is provided by a payment service provider such as, for example, PAYPAL Inc. of San Jose, Calif., that operates to provide payment services between customers and merchants. For example, customers and merchants may sign up for payment service accounts with the payment service provider and link financial accounts with the payment service accounts such that funds may be transferred between those financial accounts (e.g., a customer may use the payment service provider to transfer funds from a customer account to a merchant account to make a payment for a purchase from the merchant). As such, the payment service provider may include a database that links customers with customer payment service accounts and customer financial accounts, and merchants with merchant payment service accounts and merchant financial accounts. Furthermore, the payment application may be distributed by the payment service provider to customers so that the customer may use the payment application on their customer devices to quickly and easily instruct the payment service provider to transfer funds to a merchant account to make a payment. However, the payment application may be provided by financial account providers, third party application providers, and/or other system providers without departing from the scope of the present disclosure, and for the purposes of clarity of discussion, the provider of the payment application is referred to below as a payment application provider.

The method 100 begins at block 102 where merchant physical location personalization information is received from a merchant. Merchants in the merchant personalized payment application system are associated with merchant physical locations at which they sell products and/or services to customers. For example, each merchant in the personalized payment application system may include one or more “brick and mortar” stores that a customer may enter and purchase products and/or services. However, in other examples, the merchant physical location may include temporary stores (e.g., at a flea market, farmers market, or other temporary store location known in the art), mobile stores (e.g., a food trailer), and/or other stores known in the art without a fixed physical location. At block 102, the merchant may use a merchant device to send merchant physical location personalization information over a network (e.g., the Internet) to a payment application provider device operating by the payment application provider.

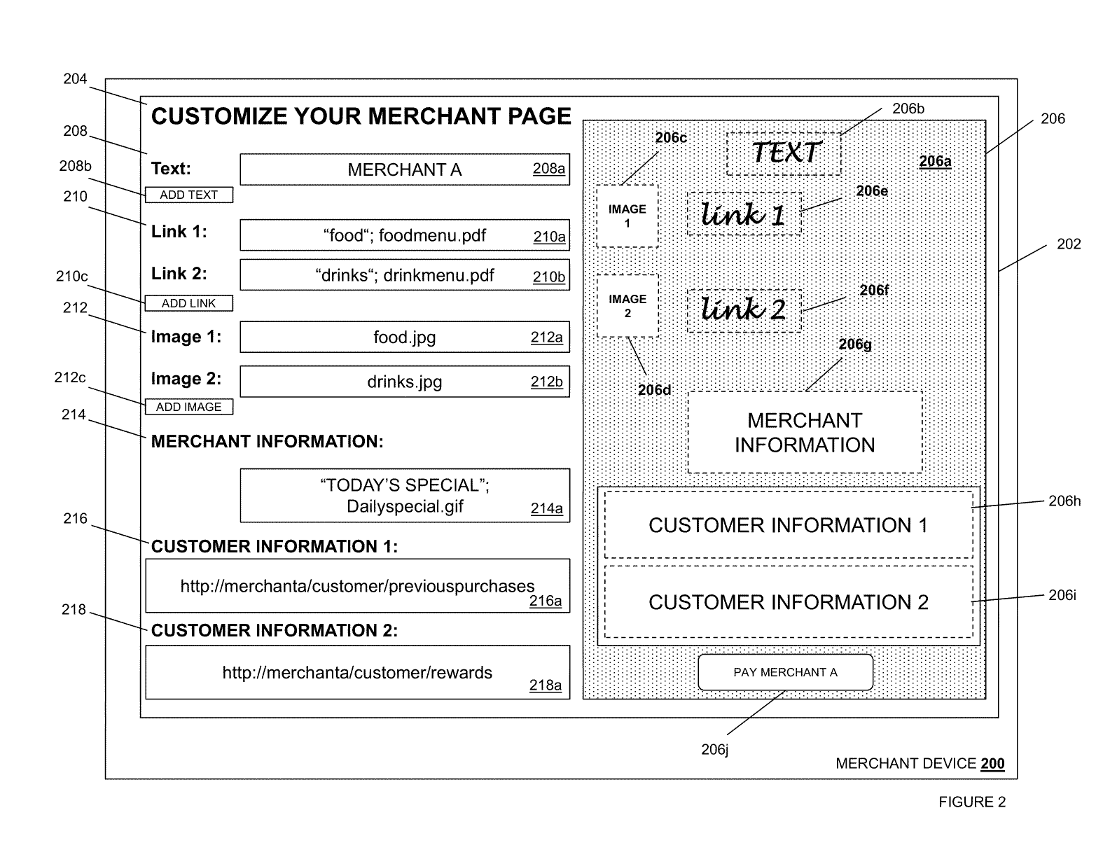

Referring now to FIG. 2, an embodiment of a merchant device 200 is illustrated that includes a display 202 displaying a merchant physical location personalization information provision screen 204. At block 102, the payment application provider may use a payment application provider device to provide the merchant physical location personalization information provision screen 204 over a network to the merchant device 200. The merchant physical location personalization information provision screen 204 discussed below, and others like it that may be provided by the payment application provider to the merchant, allow the merchant to customize the user interface or interfaces that will be provided on the payment application when that payment application is used by a customer (e.g., on a customer device) at one or more merchant physical locations of that merchant. As such, the merchant physical location personalization information provision screen 204 for a merchant may require the provision by that merchant of access information (e.g., a username and passcode), and any merchant physical location personalization information received through the merchant physical location personalization information provision screen 204 may be associated by the payment application provider with the merchant in a database along with location information for the one or more merchant physical locations of that merchant (e.g., a merchant physical location address, merchant physical location coordinates, and/or a variety of other location information known in the art.)

The merchant physical location personalization information provision screen 204 includes a payment application user interface section 206 that, as discussed below, provides an editable view of a user interface that may be presented to a customer when the customer uses the payment application at the merchant physical location. The payment application user interface 206 of the illustrated embodiment includes a plurality of editable user interface features including a background 206a, a text section 206b, a first image 206c, a second image 206d, a first link 206e, a second link 206f, a merchant information box 206g, a first customer information box 206h, a second customer information box 206i, and a pay button 206j. In an embodiment, each of the editable user interface features in the payment application user interface 206, and other editable features like them, may be added, deleted, moved, linked to a variety of different information, changed in size, changed in font, changed in color, and/or customized in a variety of different manners known in the art based on the desires of the merchant. Furthermore, the editable features on the payment application user interface 206 of the illustrated embodiment are just a few examples of editable features that may be provided, and a variety of other editable features known in the art including animations, audio, video, and/or a variety of other user interface features may be available to the merchant to add to the payment application user interface 206 while remaining within the scope of the present disclosure.

In one example, the editable features on the payment application user interface 206 may have been provided by the payment application provider as a user interface template for merchants that wish to customize the user interface (or other user interfaces) for the payment application, and may allow the user to modify those editable features as discussed above. In another example, the editable features on the payment application user interface 206 may each have been selected and placed by the merchant (e.g., the payment application user interface 206 may be initially provided to the merchant substantially blank for creation and editing, and/or including minimal necessary features for using the payment application.) In some embodiments, a user interface “wizard” may be provided that instructs or walks the merchant through the selection and placement of editable features on the payment application user interface 206.

The merchant physical location personalization information provision screen 204 also includes a text editor 208 that is associated with the text section 206b and that includes a text input box 208a and an add text button 208b. In one example, the user may provide text (e.g., “MERCHANT A”) in the text input box 208a to have that text displayed in the text section 206b, and may select the add text button 208b to add another text section to the payment application user interface 206. Other features for editing the text in the text section 206b (or other text sections) may include font editors, text size editors, text shape editors, text animation effect editors, the ability to change the positioning of the text section 206b on the payment application user interface 206, and/or a variety of other text editing functions known in the art. Furthermore, while text provided by the merchant is illustrated, merchant logo images, merchant trademark images, merchant service mark images, and/or any other merchant identifiers will fall within the scope of the present disclosure

The merchant physical location personalization information provision screen 204 also includes a link editor 210 that is associated with the link sections 206e and 206f, and that includes text and file input boxes 210a and 210b, and an add link button 210c. In one example the user may provide text and a file (e.g., “‘food’; foodmenu.pdf” in the text and file input box 210a, and ‘drinks’; drinkmenu.pdf in the text and file input box 210b) in the text and file input boxes 210a and 210b to have links to those files with that text displayed in the link sections 206e and 206f, and may select the add link button 210c to add another link section to the payment application user interface 206. Other features for editing the links in the link sections 206e and 206f (or other link sections) may include link font editors, link text size editors, link text shape editors, link text animation effect editors, the ability to change the positioning of the link sections 206e and 206f on the payment application user interface 206, and/or a variety of other link editing functions known in the art. Furthermore, while links to files provided by the merchant are illustrated, links to web pages or other information provision locations will fall within the scope of the present disclosure.

The merchant physical location personalization information provision screen 204 also includes an image editor 212 that is associated with the image sections 206c and 206d, and that includes image input boxes 212a and 212b and an add link button 212c. In one example the user may provide image files (e.g., “food.jpeg” and “drinks.jpeg”) in the image input boxes 212a and 212b to have those image files displayed in the image sections 206c and 206d, and may select the add image button 212c to add another image section to the payment application user interface 206. Other features for editing the images in the image sections 206c and 206d (or other image sections) may include image size editors, image detail editors, image shape editors, link text animation effect editors, the ability to change the positioning of the image sections 206c and 206d on the payment application user interface 206, and/or a variety of other image editing functions known in the art. Furthermore, while images provided by the merchant are illustrated, animations (e.g., .gif files), video, and/or other image or moving images will fall within the scope of the present disclosure.

The merchant physical location personalization information provision screen 204 also includes a merchant information editor 214 that is associated with the merchant information box 206g and that includes a text and file input box 214a. In one example, the user may provide text and a file (e.g., “‘TODAY'S SPECIAL’; Dailyspecial.gif”) in the text and file input box 214a to have that text and file displayed in the merchant information box 206g. While an animated image file (a .gif file) provided by the merchant is illustrated, other animations, video, audio, and/or any other method of communicating desired merchant information on the payment application user interface will fall within the scope of the present disclosure.

The merchant physical location personalization information provision screen 204 also includes a first customer information editor 216 that is associated with the first customer information box 206h and that includes an instruction input 216a. In one example, the user may provide a link (e.g., http://merchanta/customer/previouspurchases) in the instruction input 216a to have information available through that link (e.g., previous purchases of a customer using the payment application in this embodiment) displayed in the first customer information box 206h. In one example, the link or other information provided in the instruction input 216a may provide instructions to the payment application provider device to access a payment application provider database (e.g., a database including data collected by the payment application provider) to provide customer specific information (e.g., previous purchases of the customer) in the first customer information box 206h when the customer is presented the payment application user interface 206, discussed below.

The merchant physical location personalization information provision screen 204 also includes a second customer information editor 218 that is associated with the second customer information box 206i and that includes an instruction input 218a. In one example, the user may provide a link (e.g., http://merchanta/customer/rewards) in the instruction input 218a to have information available through that link (e.g., rewards/incentive information for a customer using the payment application in this embodiment) displayed in the second customer information box 206i. In one example, the link or other information provided in the instruction input 218a may provide instructions to the payment application provider device to access a merchant database (e.g., a database including data collected by the merchant) to provide customer specific information (e.g., rewards information for the customer) in the second customer information box 206i when the customer is presented the payment application user interface 206, discussed below.

While the provision of merchant physical location personalization information for the first customer information box 206h and the second customer information box 206i is discussed above as being used to provide instructions for the payment application provider device to retrieve previous purchases from a payment application provider database and rewards information from a merchant database, a wide variety of modification to customer information will fall within the scope of the present disclosure. For example, customer information may be retrieved from database providers other than the payment application provider and the merchant, including but not limited to social network providers that provide social network profiles (e.g., to the customer and friends of the customer), financial tracking application providers that allow a customer to track spending from a plurality of financial accounts, financial account providers that provider financial accounts to the customer, Internet browser application providers that provide an internet browser to the customer, and/or a variety of other database providers known in the art. Furthermore, the payment application provider may include product recommendation engines (or have access to product recommendation engines) that are configured to analyze customer information such as social network profile details, purchase histories, browsing histories, financial histories, and/or a variety of other customer information known in the art to make product recommendations for products offered by a merchant at a merchant physical location, discussed further below.

While the provision of merchant physical location personalization information via the merchant physical location personalization information provision screen 204 has been illustrated and described, other systems and methods for providing merchant physical location personalization information will fall within the scope of the present disclosure. For example, the merchant may use the merchant device 200 to provide an Extensible Markup Language (XML) file over the network to the payment application provider device, and that XML file may include any or all of the merchant physical location personalization information received by the payment application provider device at block 102. In another example, the merchant may use an application programming interface provided by the payment application provider to provide any or all of the merchant physical location personalization information received by the payment application provider device at block 102.

Thus, the merchant may use the merchant device 200 to provide a variety of merchant physical location personalization information over the network to the payment application provider device using the merchant physical location personalization information provision screen 204 and/or other screens like it. Personalization of user interfaces for the payment application that will be provided to customers using that payment application at the merchant physical location may include selection of the background 206a; selection of the color, colors, or color schemes of the user interfaces; provision of the layout of the user interfaces; selection of icons on the user interfaces; selection of button inputs on the user interfaces; selection of animations on the user interfaces; provision of files or links that may be accessed with the user interfaces; selection of audio that may be provided on the user interfaces; selection of video that may be provided on the user interfaces; and/or a variety of other user interface information known in the art. As such, following block 102 of the method 100, the payment application provider device may associate in a database a plurality of merchant physical location personalization information with one or more merchant physical locations of the merchant that provided it, and that merchant physical location personalization information may be used to provide one or more user interfaces, screens, pages, and/or other elements of the payment application personalized for that merchant and accessible by a customer that uses the payment application at that merchants physical location or locations.

The method 100 then proceeds to block 104 where a customer location is received from a customer and an associated merchant physical location is determined. As discussed in further detail below, a customer in the merchant personalized payment application system includes a customer device such as, for example, a mobile phone, that includes the payment application and that is configured to provide a customer location over a network (e.g., the Internet) to the payment application provider device. For example, the customer device may include a location determination device such as a Global Positioning System (GPS) that is operable to determine a current location of the customer (i.e., a customer location) that may be sent over the network to the payment application provider device. In another example, the customer device may include an application that allows the customer to “check in” to the merchant physical location (e.g., the Foursquare application available from Foursquare Labs, Inc. of New York City, New York), and the customer location may be shared between that application or application provider and the payment application provider device. In another example, the customer may provide a merchant name, merchant address, or other identifying information about a merchant physical location in the payment application at block 104.

In another example, the merchant physical location may include a beacon such as, for example, a Bluetooth(r) technology beacon, a Bluetooth® low energy (BLE) technology beacon, and/or a variety of other beacons known in the art. When the customer enters the merchant physical location, communication between the beacon and the customer device may result in the determination that the customer location is associated with the merchant physical location. Furthermore, the merchant physical location may include a plurality of local beacons at different areas within the merchant physical location, and that merchant physical location personalization information discussed below may differ depending on which of the beacons in the merchant physical location the customer device is communicating with. As such, the payment application discussed below may be personalized differently within a merchant physical location depending on which area of the merchant physical location the customer is in. For example, a merchant may sell both food and products within a merchant physical location, and the payment application on the customer device may be personalized for the food sold by the merchant when the customer is located in the areas within the merchant physical location at which food is sold, while being personalized for the products sold by the merchant when the customer is located in the areas within the merchant physical location at which products are sold. While a few examples have been provided, one of skill in the art in possession of the present disclosure will recognize that a wide variety of customer location provisioning systems will fall within the scope of the present disclosure.

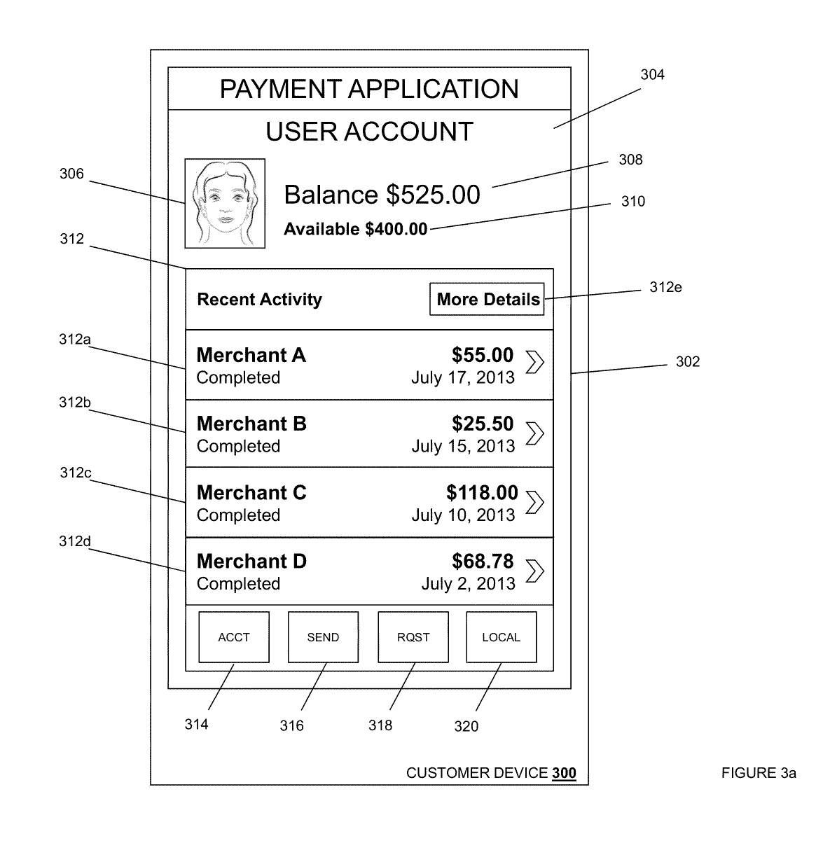

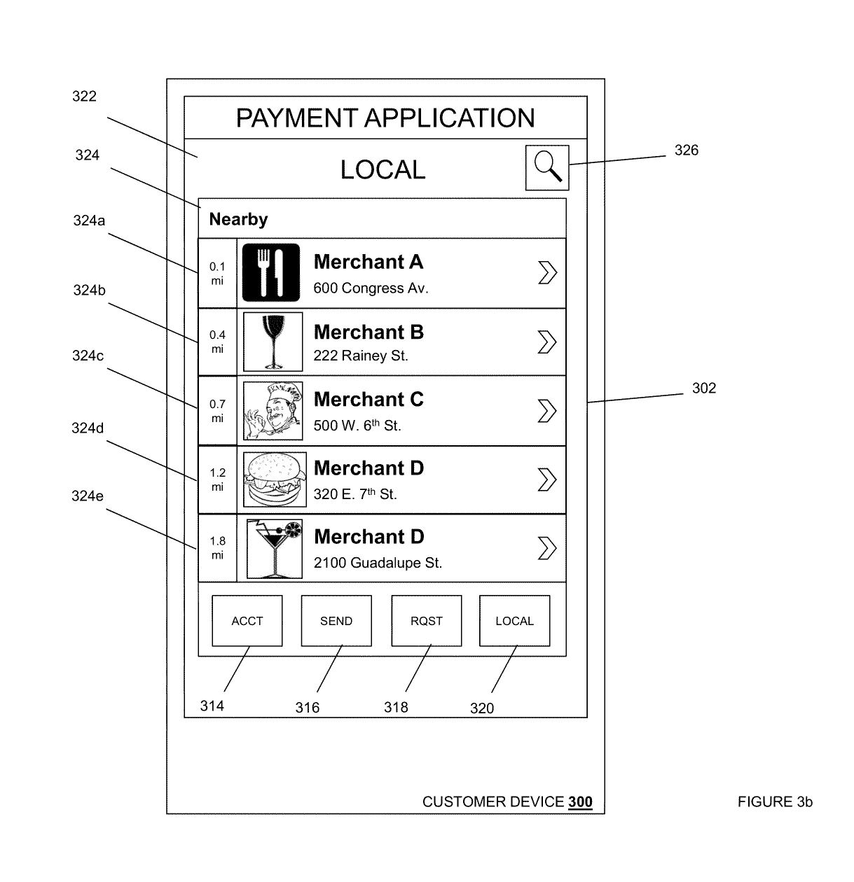

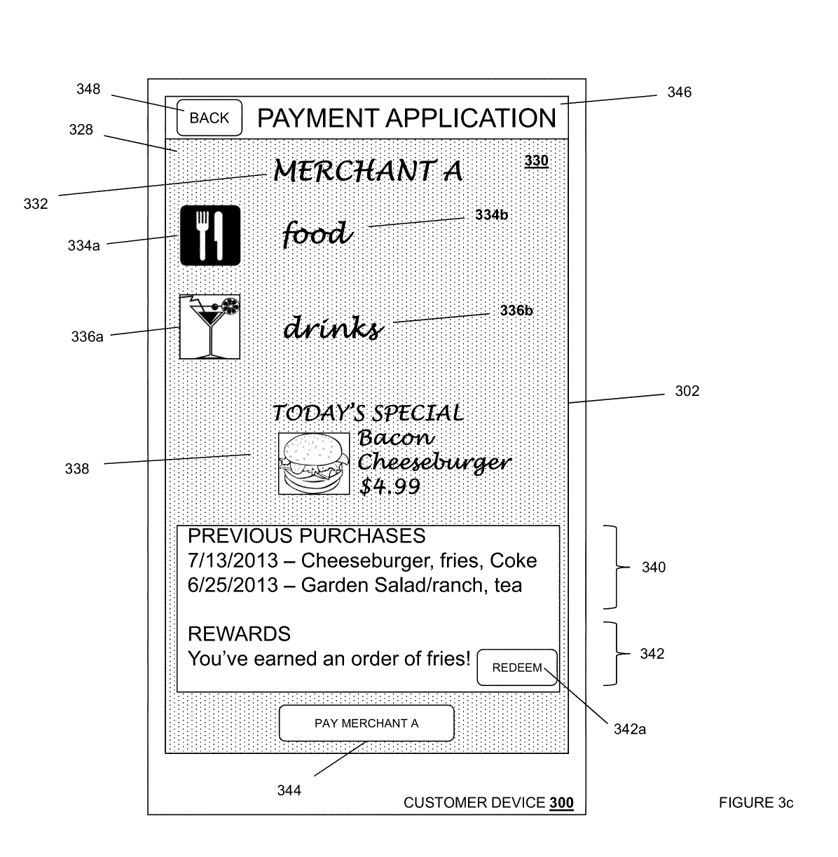

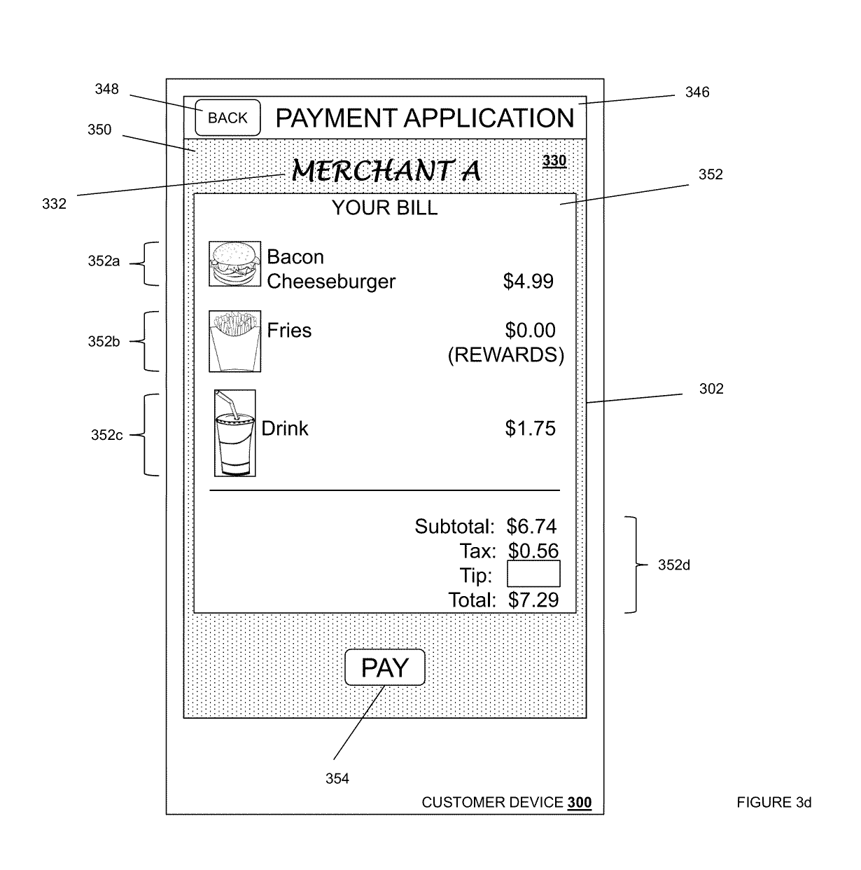

Referring now to FIGS. 3a and 3b, an embodiment of a customer device 300 is illustrated. The customer device 300 includes a display 302 and a payment application such as, for example, the PAYPAL mobile payment application available from PAYPAL, Inc. of San Jose, Calif. In the embodiment illustrated in FIG. 3a, the payment application on the customer device 300 has been launched to provide a payment application home screen 304. For example, the payment application may be launched by the customer (e.g., in response to the customer selecting a payment application icon on a home screen displayed on the customer device 300), automatically (e.g., in response to the customer entering a merchant physical location, in response to the customer initiating a transaction with the merchant at the merchant physical location followed by communication between a merchant device and the customer device 300 that causes the payment application to automatically launch, etc.), and/or according to a variety of other application launch scenarios known in the art.

In the illustrated embodiment, the home screen 304 provides information about a user account, including a customer image 306, an account balance 308 (e.g., for a payment account provided by a payment service provider), and an available balance 310 (e.g., an amount available from the account balance 308 for use in making payment). The home screen 304 also includes a recent activity section 312 including a plurality of recent purchase activity 312a, 312b, 312c, and 312d of the customer. For example, the recent purchase activity 312a includes details about a purchase from merchant A for $55.00 completed on Jul. 17, 2013, and may be selected to view additional details about that purchase. Similarly, the other recent purchase activity 312b, 312c, and 312d includes similar details and functionality, and the recent activity section 312 may allow a customer to scroll through recent purchase activity (e.g., by performing a touch operation such as a “swipe”) to view any other purchases made using the payment application, or view additional details about recent activity by selecting a more details button 312e. The home screen 304 also includes a plurality of payment application function buttons, including in the illustrated embodiment, an account button 314, a send button 316, a request button 318, and a local button 320. For example, selection of the account button 314 may bring up the home screen 304 that provides the information about the user account; selection of the send button 316 may bring up a send money screen (not illustrated) that allows the customer to send money using the payment application; selection of the request button 318 may bring up a request money screen (not illustrated) that allows the customer to request money using the payment application; and selection of the local button 320 may bring up a merchant detection screen (discussed below) that allows the customer to select a local merchant to make a payment to.

Referring now to FIG. 3b, the local button 320 on the home screen 304 of the payment application has been selected such that the payment application provides a merchant detection screen 322 on the display 302 of the customer device 300. The merchant detection screen 322 includes a detected merchants section 324 that includes a plurality of detected merchants such as, for example, the detected merchants 324a, 324b, 324c, 324d, and 324e in the illustrated embodiment. Each of the detected merchants 324a-e includes information about that detected merchant such as, for the detected merchant 324a, that merchant A has been detected, is 0.1 miles from the customer's current location, and is located at 600 Congress Av. As can be seen in FIG. 3b, each of the detected merchants 324b, 324c, 324d, and 324e includes similar information, and any of the detected merchants 324a-e may be selected to be provided one or more personalized merchant physical location screens, discussed in further detail below. In addition, a search button 326 may allow a customer to search for a merchant/merchant physical location if that merchant/merchant physical location is not provided in the detected merchants section 324.

Thus, in the illustrated embodiment, at block 104 the customer device 300 may have determined its current location (i.e., a customer location) using a location determination device and sent that location over the network to the payment application provider device. In response, the payment application provider device used the customer location to determine one or more merchant physical locations that are associated with that current location in a database (e.g., merchant physical locations at that customer location, merchant physical locations within a predetermined distance of that merchant physical location, etc.), and provided those merchant physical locations as the detected merchants 324a-e on the merchant detection screen 322.

However, in other embodiments, the customer may launch the payment application as discussed above, and in response to the launching of the payment application, the customer device may automatically send the customer location to the payment application provider device. In response to receiving the customer location, the system provider may determine a merchant physical location corresponds to that customer location (e.g., a merchant physical location at that customer location, a merchant physical location that is closest to that customer location, etc.), and automatically provide the personalized merchant physical location screens discussed below. In another example, the customer device 300 may periodically send the customer location to the payment application provider device without any input from the customer, and that customer location may be used by the payment application provider to determine a corresponding merchant physical location. While a few examples have been provided, one of skill in the art in possession of the present disclosure will recognize that the customer location may be provided to the payment application provider device, and its correspondence with a merchant physical location may be determined, in a variety of manners while remaining within the scope of the present disclosure.

The method 100 then proceeds to block 106 where merchant physical location personalization information for the merchant physical location is retrieved. Referring first to the embodiment illustrated in FIG. 3b, the customer may select the detected merchant 324a in the detected merchant section 324 on merchant detection screen 322 to send an instruction over the network to the payment application provider device to retrieve merchant physical location personalization information that was previously provided by merchant A (e.g., according to block 102 of the method 100), and use that merchant physical location personalization information to provide one or more personalized merchant physical location screens. In another embodiment, in response to receiving a customer location (e.g., sent from a customer device in response to the customer launching the payment application, sent from a customer device automatically in response to entering the merchant physical location, etc.), the payment application provider device may automatically determine a corresponding merchant physical location and retrieve merchant physical location personalization information that was previously provided by the merchant at that merchant physical location (e.g., according to block 102 of the method 100), and use that merchant physical location personalization information to provide one or more personalized merchant physical location screens.

Referring now to FIGS. 1, 3c, and 3d, the method 100 then proceeds to block 108 where merchant physical location personalization information is provided as a payment application user interface. As discussed in more detail below, the payment application provider device may use the merchant physical location personalization information retrieved at block 106 to provide user interfaces for the payment application as one or more personalized merchant physical location screens. Those personalized merchant physical location screens provide the payment application for display on the customer device in a manner that is personalized for the merchant at the merchant physical location such that the customer is presented with a merchant “branded” payment application that appears to come from the merchant itself, rather than the payment application provider or other entity providing the payment application.

Referring first to FIG. 3c, the customer device 300 is illustrated providing a personalized merchant physical location screen 328 that includes the merchant physical location personalization information retrieved at block 106 and is provided as a user interface on the payment application. In an embodiment, the personalized merchant physical location screen 328 has been provided by the payment application provider device over the network to the customer device 300 in response to the customer selecting the detected merchant 324a on the merchant detection screen 322 illustrated in FIG. 3b. In another embodiment, the personalized merchant physical location screen 328 has been provided by the payment application provider device over the network to the customer device 300 in response to the customer launching the payment application in the merchant physical location associated with the merchant A, or automatically in response to the customer entering the merchant physical location associated with the merchant A.

The personalized merchant physical location screen 328 includes a background 330 that may have been provided and/or selected as merchant physical location personalization information by the merchant at block 102. The personalized merchant physical location screen 328 also includes merchant identifying text 332 that may have been provided and/or selected as merchant physical location personalization information by the merchant at block 102, and that in the illustrated embodiment identifies the Merchant A. While only merchant identifying text 332 is illustrated, the merchant A may have provided and/or selected a merchant logo, trademark, animation, and/or other merchant identifiers known in the art. The personalized merchant physical location screen 328 also includes a food image 334a and a food menu link 334b that may have been provided and/or selected as merchant physical location personalization information by the merchant at block 102, and that in the illustrated embodiment includes an image of food and a link to a food menu of merchant A that the customer may select to retrieve a web page or file including a menu of food provided for sale by the merchant A at the merchant physical location. Similarly, the personalized merchant physical location screen 328 also includes a drink image 336a and a drink menu link 336b that may have been provided and/or selected as merchant physical location personalization information by the merchant at block 102, and that in the illustrated embodiment includes an image of a drink and a link to a drink menu of merchant A that the customer may select to retrieve a web page or file including a menu of drinks provided for sale by the merchant A at the merchant physical location.

The personalized merchant physical location screen 328 also includes a merchant special section 338 that may have been provided and/or selected as merchant physical location personalization information by the merchant at block 102, and that in the illustrated embodiment includes an animated image (e.g., a .gif file) of an item on sale by the merchant at the physical location, as well as a description of the item on sale. The personalized merchant physical location screen 328 also includes a first customer information section 340 that may have been provided and/or selected as merchant physical location personalization information by the merchant at block 102, and that in the illustrated embodiment includes a plurality of previous purchases by the customer associated with the customer device from the merchant associated with the merchant physical location. In one example, the first customer information section 340 may be provided by the payment application provider device retrieving a purchase history from a database (e.g., a payment service provider retrieving a purchase history for the customer from a payment service provider database), filtering that payment history for purchases from the merchant associated with the merchant physical location, and providing those purchases in the first customer information section 340.

The personalized merchant physical location screen 328 also includes a second customer information section 342 that may have been provided and/or selected as merchant physical location personalization information by the merchant at block 102, and that in the illustrated embodiment includes one or more rewards earned by the customer associated with the customer device from the merchant associated with the merchant physical location. In one example, the second customer information section 342 may be provided by the payment application provider device retrieving rewards details from a database (e.g., a payment service provider retrieving rewards details for the customer from a merchant database) and providing those rewards details in the second customer information section 342. In the illustrated embodiment, the second customer information section 342 includes a redeem button 342a that the customer may select to redeem an earned reward.

While a few examples of customer information have been provided, a variety of other types of customer information may be provided on the personalized merchant physical location screen 328 that will fall within the scope of the present disclosure. As discussed above, in an embodiment, the merchant and/or the payment application provider may include a recommendation engine (or have access to a recommendation) that is configured to, for example, review a purchase history of the customer (e.g., as detailed in the first customer information 340) and determine one or more products available from the merchant to recommend to the customer. In a specific example, the purchase history may indicate that the customer typically purchases a cheeseburger, fries, and a Coke(r) on Tuesdays of each week at lunch (e.g., from the merchant A and/or other similar merchants), and in response to the payment application being used at the merchant physical location of Merchant A on a Tuesday, the personalized merchant physical location screen 328 may include customer information that recommends that the customer purchase a cheeseburger, fries, and a Coke® from the merchant A. In some situations, the merchant A may be recommended by the payment application provider to offer a discount to the customer for the cheeseburger, fries, and a Coke(r) to further incentive that purchase by the customer. In other examples, the purchase history of the customer may indicate a favorite (e.g., most purchased) meal, drink, appetizer, or other product, and the personalized merchant physical location screen 328 may include those or similar products offered by the merchant A as recommendations to the customer.

The personalized merchant physical location screen 328 also includes a payment button 344 that may have been provided and/or selected as merchant physical location personalization information by the merchant at block 102, or that may be provided automatically by the payment applications (e.g., but may be customizable by the merchant with regards to color, icon used, location on the user interface, and/or with regard to any other feature of the payment button 344). In the illustrated embodiment, the personalized merchant physical location screen 328 includes a payment application indicator 346, along with a back button 348 that may be selected by the customer to return to, for example, the home screen 304, the merchant detection screen 322, and/or any other screen provided by the payment application. However, in some embodiments, the payment application indicator 346 and/or back button 348 may be omitted from the personalized merchant physical location screen 328 such that there is no indication that the personalized merchant physical location screen 328 is being provided by the payment application provider, and rather appears as through the personalized merchant physical location screen 328 is being provided by the merchant associated with the merchant physical location.

Referring now to FIG. 3d, the customer device 300 is illustrated providing a personalized merchant physical location screen 350 that includes the merchant physical location personalization information retrieved at block 106 and is provided as a user interface on the payment application. In an embodiment, the personalized merchant physical location screen 350 has been provided by the payment application provider device over the network to the customer device 300 in response to the customer selecting the payment button 344 on the personalized merchant physical location screen 328 illustrated in FIG. 3c. For example, after being presented with the personalized merchant physical location screen 328, the user may select several items for purchase from the merchant. In some embodiments, those items may be selected using the menus provided on the personalized merchant physical location screen 328 through the food menu link 334b and the drink menu link 336b (i.e., the customer may make their order through the customer device 300). In other embodiments, the customer may order from the merchant and the merchant may enter that order on a merchant device, and the selection of the payment button 344 may cause the customer device to communicate with that merchant device to retrieve the order details displayed on the personalized merchant physical location screen 350, discussed below.

In another embodiment, the personalized merchant physical location screen 350 has been provided by the payment application provider device over the network to the customer device 300 in response to the customer launching the payment application in the merchant physical location associated with the merchant A and following the placement of an order by the customer with the merchant. Similarly as discussed above, the customer may order from the merchant and the merchant may enter that order on a merchant device, and the subsequent launching of the payment application may cause the customer device to communicate with that merchant device to retrieve the order details, discussed below. In some embodiments, the merchant device may communicate with the customer device 300 subsequent to receiving a customer order from the customer, and that communication may cause the payment application to launch automatically on the customer device 300 and provide the personalized merchant physical location screen 350.

The personalized merchant physical location screen 350 includes the background 330 and the merchant identifying text 332 that is discussed above and that may have been provided and/or selected as merchant physical location personalization information by the merchant at block 102. The personalized merchant physical location screen 350 also includes the payment application indicator 346 and back button 348 discussed above, either or both of which may be omitted in some embodiments as also discussed above.

The personalized merchant physical location screen 350 also includes a bill section 352 that, in the illustrated embodiment, includes a plurality of items selected by the customer at the merchant physical location for purchase from the merchant. The plurality of items includes a first item section 352a that details a first item selected by the customer, that includes information that may have been provided and/or selected as merchant physical location personalization information by the merchant at block 102, and that in the illustrated embodiment includes an image of the item, a text description of the item, and a price of the item. In some embodiments, some or all of the information in the first item section 352a may have been retrieved by the payment application provider device from a menu provided by the merchant at block 102. Furthermore, in the illustrated embodiment, the first item section 352a details a sale item (e.g., the item included in the merchant special section 338 on the personalized merchant physical location screen 328), and the payment application provider device may have adjusted the price of the item based on that item being on special or otherwise reduced in price.

The plurality of items includes a second item section 352b that details a second item selected by the customer, that includes information that may have been provided and/or selected as merchant physical location personalization information by the merchant at block 102, and that in the illustrated embodiment includes an image of the item, a text description of the item, and a price of the item. In some embodiments, some or all of the information in the second item section 352b may have been retrieved by the payment application provider device from a menu provided by the merchant at block 102. Furthermore, in the illustrated embodiment, the second item section 352b details an item associated with a customer reward, and the payment application provider device may have adjusted the price of the item based on that reward while providing an indication that the reward was used. The plurality of items includes a third item section 352c that details a third item selected by the customer, includes information that may have been provided and/or selected as merchant physical location personalization information by the merchant at block 102, and that in the illustrated embodiment includes an image of the item, a text description of the item, and a price of the item. In some embodiments, some or all of the information in the third item section 352c may have been retrieved by the payment application provider device from a menu provided by the merchant at block 102.

The bill section 352 also includes a purchase amount section 352d that includes a subtotal of the prices of the items, a tax amount for the purchase, a tip input box in which a customer may provide a tip amount, and a total amount of the payment owed by the customer and that may be made using the payment application to transfer they payment amount from a financial account of the customer to a financial account of the merchant. The personalized merchant physical location screen 350 also includes a pay button 354 that the customer may select to send an instruction to the payment application provider device (e.g., over a network) to make a payment from a financial account of the customer to a financial account of the merchant.

Thus, in the embodiments illustrated in FIGS. 3c and 3d, a restaurant merchant (e.g., merchant A) has provided a payment application provider a plurality of merchant physical location personalization information that allows for the personalization of the payment application provided by the payment application provider to customers when they enter the restaurant of the restaurant merchant and use the payment application to make a payment to the restaurant merchant. In the example provided, the restaurant merchant has customized the payment application such that customer using it in the merchant physical location is presented with the restaurant merchants logo, a customized background, food and drink menus, the daily special, details of previous purchases by the customer from the merchant, and rewards earned by the customer from the merchant. However, such personalization may be extended to a wide variety of merchants, one example of which is provided below.

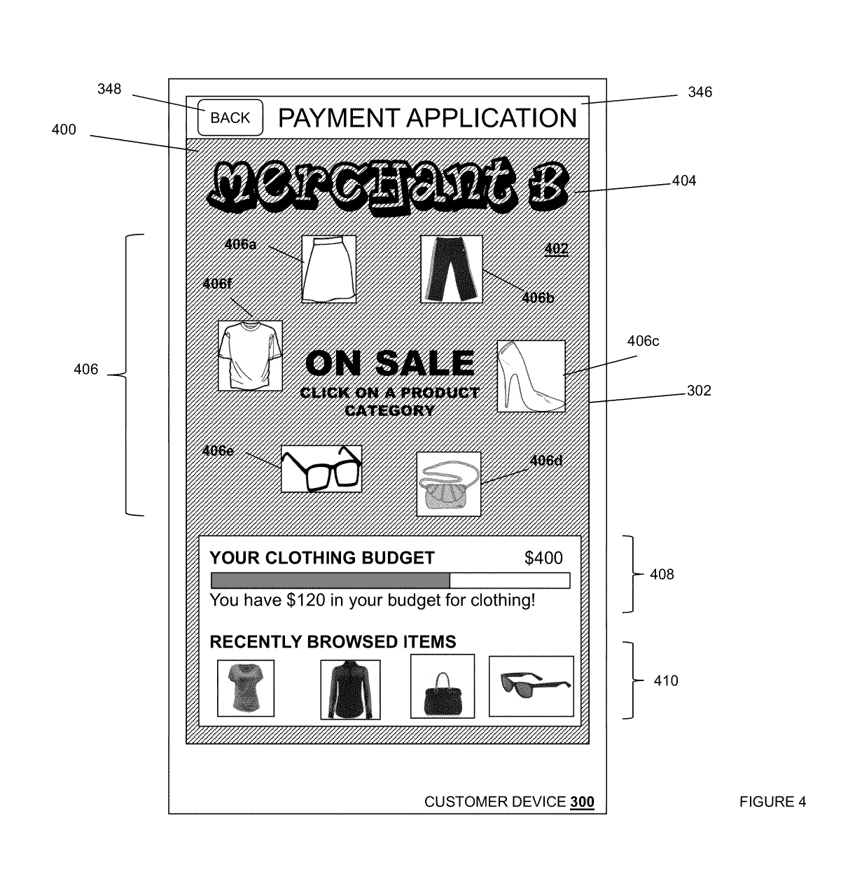

Referring now to FIG. 4, the customer device 300 is illustrated providing a personalized merchant physical location screen 400 on the display 302 that includes merchant physical location personalization information that was provided from a merchant (e.g., merchant B) that is different from the merchant that provided the merchant physical location personalization information that was used to create the personalized merchant physical location screens 328 and 350. In the illustrated embodiment, the merchant B is a clothing merchant, and in one example, the customer may have dined with merchant A and paid using the payment application as detailed above with reference to FIGS. 3c and 3d, and followed that visit to merchant A with a clothing shopping trip to merchant B, where the customer may use the same payment application to be provided the personalized merchant physical location screen 400 discussed below. The method 100 with respect to FIG. 4 may be performed substantially as discussed above, but at block 108, the payment application provider device provides the personalized merchant physical location screen 400 over the network to the customer device 300.

The personalized merchant physical location screen 400 includes a background 402 that may have been provided and/or selected as merchant physical location personalization information by the merchant at block 102. The personalized merchant physical location screen 400 also includes merchant identifying text 400 that may have been provided and/or selected as merchant physical location personalization information by the merchant at block 102, and that in the illustrated embodiment identifies the Merchant B. While only merchant identifying text 402 is illustrated, the merchant B may provide and/or select a merchant logo, trademark, animation, and/or other merchant identifiers known in the art.

The personalized merchant physical location screen 400 also includes a sale section 406 that includes sales text 406a and a plurality of product image links 406b, 406c, 406d, 406e, 406f, and 406g that may have been provided and/or selected as merchant physical location personalization information by the merchant at block 102. In one example, the merchant B may have provided the sales text 406a and the plurality of product image links 406b-g to have the payment application personalized for a sale of products that the merchant B is having. In the illustrated embodiment, the sales text 406a communicates to the user that merchant B is having a sale and that any of the product image links 406b-g may be selected to view items on sale. Thus, each of the product image links 406b-g may include an image of a product type, and a selection of a product image link by the customer may send an instruction from the customer device to the payment application provider device to return a list of products of that product type that are on sale, images of those products, descriptions of those products, and/or a variety of other product information that is known in the art and that may have been provided by the merchant at block 102.

The personalized merchant physical location screen 400 also includes a first customer information section 408 that may have been provided and/or selected as merchant physical location personalization information by the merchant at block 102, and that in the illustrated embodiment includes a clothing budget of the customer associated with the customer device. In one example, the first customer information section 408 may be provided by the payment application provider device retrieving a customer clothing budget from a database (e.g., a payment service provider retrieving a customer clothing budget from a customer finance tracking application database of a financial tracking application provider), determining an amount under that budget that is available, and providing a graphic illustrating the customer clothing budget status and text informing the customer of an amount they may spent while remaining under the budget.

The personalized merchant physical location screen 400 also includes a second customer information section 410 that may have been provided and/or selected as merchant physical location personalization information by the merchant at block 102, and that in the illustrated embodiment includes a plurality of items recently browsed (e.g., via an Internet browser) by the customer associated with the customer device. In one example, the second customer information section 410 may be provided by the payment application provider device retrieving product browsing history of the customer from a database (e.g., a payment service provider retrieving a plurality of products browsed by the customer using an Internet browser from an Internet browser database), filtering those items for clothing products browsed that are available at the merchant, and providing those products in the second customer information section 410. In the illustrated embodiment, the second customer information section 410 includes product image links retrieved for clothing products recently browsed by the customer, and those image links may be selected by the customer retrieve more information about those products (e.g., prices, their location within the merchant physical location, etc.).

While a few examples of customer information have been provided, other types of customer information may be provided on the personalized merchant physical location screen 400. In an embodiment, the merchant and/or the payment application provider may include a recommendation engine that is configured, for example, to review a browsing history of the customer (e.g., as detailed in the second customer information 410) and determine one or more products available at the merchant physical location to recommend to the customer. In a specific example, the browsing history may indicate that the customer has recently been browsing blue jeans offered by a variety of merchants, and in response to the payment application being used at the merchant physical location of Merchant B, the personalized merchant physical location screen 400 may include customer information that recommends one or more pairs of blue jeans available at the merchant physical location that are of the same style that the customer browsed, are in the customer's size, and/or include a variety of other recommendation characteristics known in the art. In other examples, the recommendation engine may be configured to review a social media account of the customer and or social media accounts of the customer's friends to determine products that the customer may be interested, and may then make recommendations of those products that are available at the merchant physical location to the customer as customer information on the personalized merchant physical location screen 400.

While examples of the payment application personalized for two different merchant physical locations (e.g., a restaurant merchant and a clothing merchant) have been provided, one of skill in the art in possession of the present disclosure will recognize that the payment application may be personalized for any merchant such that when a customer uses that payment application in one or more physical locations of a merchant, the payment application will provide personalized merchant physical location screens that include user interfaces customized for that merchant. Thus, a customer using the payment application in different merchant physical locations may be presented with personalized merchant physical location screens that differ greatly from each other on the same payment application. Furthermore, while a few examples of merchant physical location personalization information have been provided that includes backgrounds, colors, text, images, icons, layouts, customer information collected by a payment service provider, customer information collected by a merchant, customer information collected by a third party, links, image links, files, and more, one of skill in the art will recognize that merchant physical location information may include animations, video, audio, recommendations (e.g., based on a purchase history, social network profile, financial history, etc.), and/or a variety of other application features known in the art.

Thus, systems and methods for providing a payment application that may be personalized for any of a plurality of different merchant physical locations have been described that allow different merchants to provide a payment application provider customization information for a payment application that allows the payment application to be personalized for each of those merchants. When a customer is located at a merchant physical location of the merchant and uses the payment application, that payment application may then be personalized for the merchant physical location and presented to the customer such that it is “branded” for that merchant or otherwise includes specific, distinct features associated with that merchant. Such systems and methods allow for the payment application functionality to be extended from simple payment provision to product shopping, product marketing, product recommendations, product ordering, and/or a variety of other beneficial merchant specific functions known in the art. The system and methods of the present disclosure may be used to offload the provisioning of a merchant website from the merchant, and provide a seamless payment experience for a customer when that customer is in a merchant physical location by customizing the payment application for that merchant.

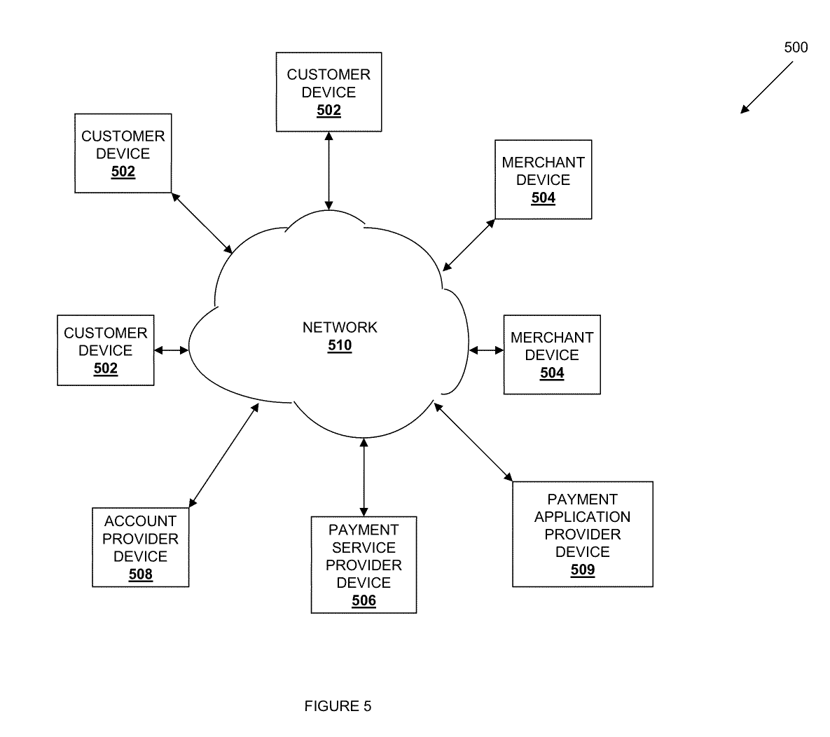

Referring now to FIG. 5, an embodiment of a network-based system 500 for implementing one or more processes described herein is illustrated. As shown, network-based system 500 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 5 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 500 illustrated in FIG. 5 includes a plurality of customer devices 502, a plurality of merchant devices 504, a payment service provider device 506, an account provider device 508, and/or a payment application provider device 509 in communication over a network 510. Any of the customer devices 502 may be the customer device 300, discussed above. Any of the merchant devices 504 may be the merchant device 200 discussed above and may be operated by the merchants discussed above. The payment service provider device 506 may be the payment service provider devices discussed above and may be operated by a payment service provider such as, for example, PAYPAL Inc. of San Jose, Calif. The account provider device 508 may be the account provider devices discussed above and may be operated by the account providers discussed above such as, for example, credit card account providers, bank account providers, savings account providers, and a variety of other account providers known in the art. The payment application provider device 509 may be the payment application provider devices discussed above and may be operated by the payment application providers discussed above.

The customer devices 502, merchant devices 504, payment service provider device 506, account provider device 508, and/or payment application provider device 509 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 500, and/or accessible over the network 510.

The network 510 may be implemented as a single network or a combination of multiple networks. For example, in various embodiments, the network 510 may include the Internet and/or one or more intranets, landline networks, wireless networks, and/or other appropriate types of networks.

The customer devices 502 may be implemented using any appropriate combination of hardware and/or software configured for wired and/or wireless communication over network 510. For example, in one embodiment, the customer devices 502 may be implemented as a personal computer of a user in communication with the Internet. In other embodiments, the customer devices 502 may be a smart phone, personal digital assistant (PDA), laptop computer, and/or other types of computing devices.

The customer devices 502 may include one or more browser applications which may be used, for example, to provide a convenient interface to permit the customer to browse information available over the network 510. For example, in one embodiment, the browser application may be implemented as a web browser configured to view information available over the Internet.

The customer devices 502 may also include one or more toolbar applications which may be used, for example, to provide user-side processing for performing desired tasks in response to operations selected by the customer. In one embodiment, the toolbar application may display a user interface in connection with the browser application.

The customer devices 502 may further include other applications as may be desired in particular embodiments to provide desired features to the customer device 502. In particular, the other applications may include the payment application discussed above for facilitating payments assisted by a payment service provider through the payment service provider device 506. The other applications may also include security applications for implementing user-side security features, programmatic user applications for interfacing with appropriate application programming interfaces (APIs) over the network 510, or other types of applications. Email and/or text applications may also be included, which allow the customer to send and receive emails and/or text messages through the network 510. The customer device 502 includes one or more user and/or device identifiers which may be implemented, for example, as operating system registry entries, cookies associated with the browser application, identifiers associated with hardware of the customer device 502, or other appropriate identifiers, such as a phone number. In one embodiment, the user identifier may be used by the payment service provider device 506 and/or account provider device 508 to associate the customer with a particular account as further described herein.

The merchant devices 504 may be maintained, for example, by conventional or on-line merchants, conventional or digital goods sellers, individual sellers, and/or application developers offering various products and/or services in exchange for payment to be received conventionally or over the network 510. In this regard, the merchant devices 504 may include a database identifying available products and/or services (e.g., collectively referred to as items) which may be made available for viewing and purchase by the customers.

The merchant devices 504 also include a checkout application which may be configured to facilitate the purchase by the payer of items. The checkout application may be configured to accept payment information from the customers through the customer devices 502, the account provider through the account provider device 508, and/or from the payment service provider through the payment service provider device 506 over the network 510.

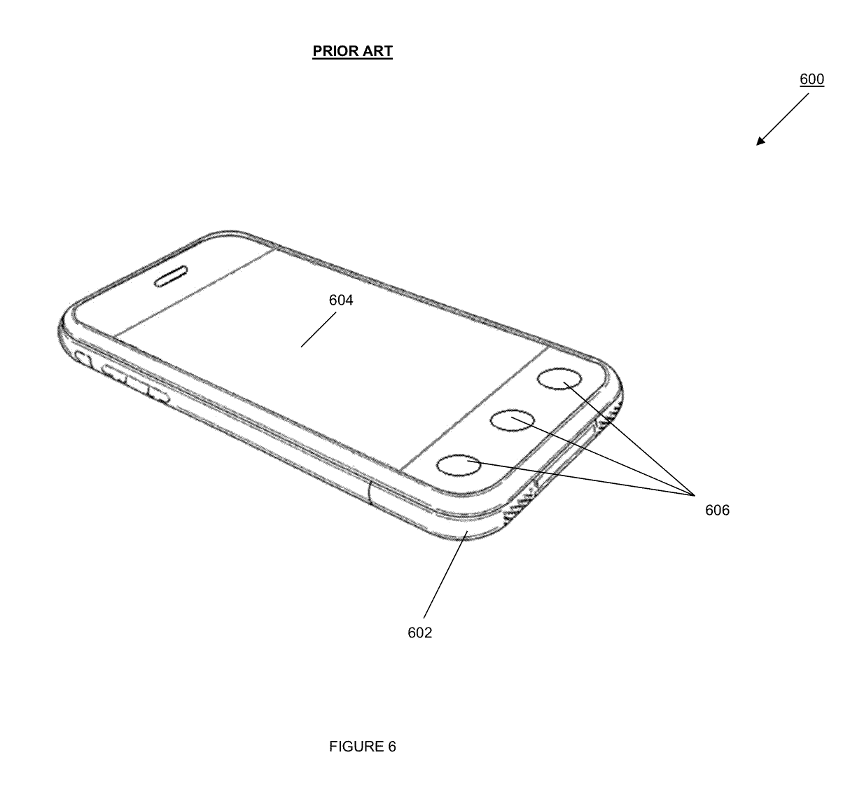

Referring now to FIG. 6, an embodiment of a customer device 600 is illustrated. The customer device 600 may be any of the customer devices 300 and/or 502. The customer device 600 includes a chassis 602 having a display 604 and an input device including the display 604 and a plurality of input buttons 606. One of skill in the art will recognize that the customer device 600 is a portable or mobile phone including a touch screen input device and a plurality of input buttons that allow the functionality discussed above with reference to the method 100. However, a variety of other portable/mobile customer devices and/or desktop customer devices may be used in the method 100 without departing from the scope of the present disclosure.

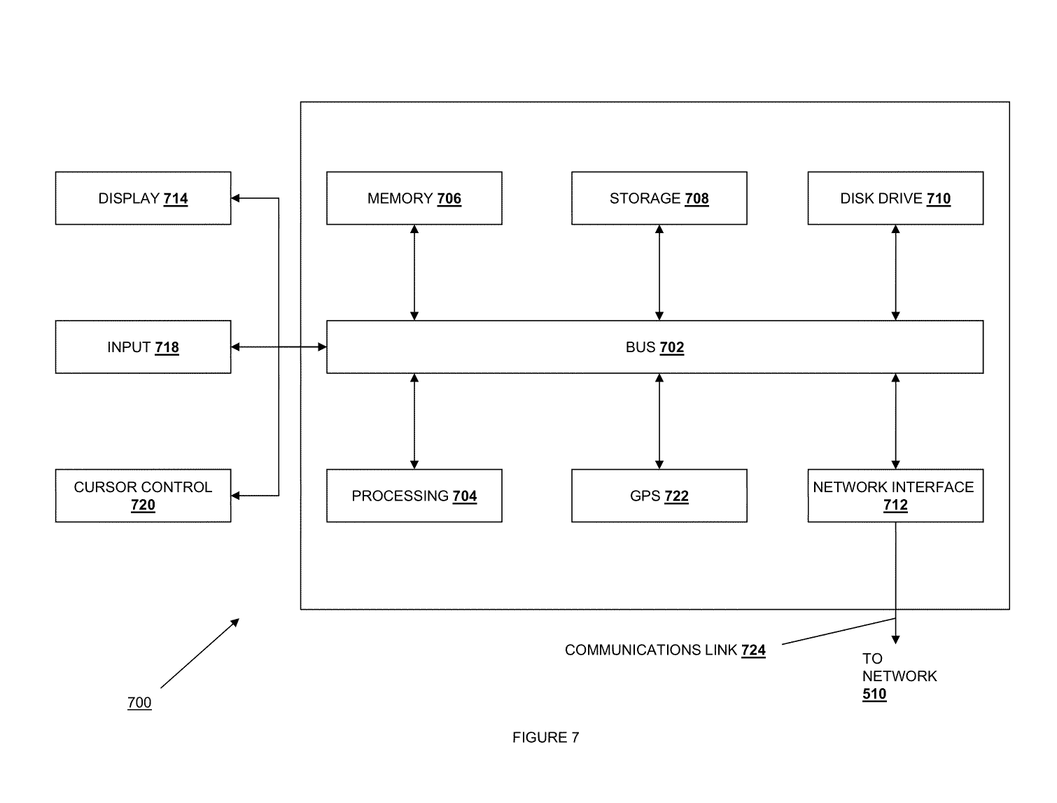

Referring now to FIG. 7, an embodiment of a computer system 700 suitable for implementing, for example, the customer devices 300, 502, or 600, the merchant devices 200 or 504, the payment service provider device 506, the account provider device 508, and/or the payment application provider device 509 is illustrated. It should be appreciated that other devices utilized by customer, merchants, payment service providers, account providers, and/or payment application providers in the payment application personalization system discussed above may be implemented as the computer system 700 in a manner as follows.

In accordance with various embodiments of the present disclosure, computer system 700, such as a computer and/or a network server, includes a bus 702 or other communication mechanism for communicating information, which interconnects subsystems and components, such as a processing component 704 (e.g., processor, micro-controller, digital signal processor (DSP), etc.), a system memory component 706 (e.g., RAM), a static storage component 708 (e.g., ROM), a disk drive component 710 (e.g., magnetic or optical), a network interface component 712 (e.g., modem or Ethernet card), a display component 714 (e.g., CRT or LCD), an input component 718 (e.g., keyboard, keypad, or virtual keyboard), a cursor control component 720 (e.g., mouse, pointer, or trackball), and/or a location determination component 722 (e.g., a Global Positioning System (GPS) device as illustrated, a cell tower triangulation device, and/or a variety of other location determination devices known in the art.) In one implementation, the disk drive component 710 may comprise a database having one or more disk drive components.

In accordance with embodiments of the present disclosure, the computer system 700 performs specific operations by the processor 704 executing one or more sequences of instructions contained in the memory component 706, such as described herein with respect to the customer device 300, 502, and 600, the merchant devices 300 and 504, the payment service provider device 506, the account provider device 508, and/or the payment application provider device 509. Such instructions may be read into the system memory component 706 from another computer readable medium, such as the static storage component 708 or the disk drive component 710. In other embodiments, hard-wired circuitry may be used in place of or in combination with software instructions to implement the present disclosure.

Logic may be encoded in a computer readable medium, which may refer to any medium that participates in providing instructions to the processor 704 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 710, volatile media includes dynamic memory, such as the system memory component 706, and transmission media includes coaxial cables, copper wire, and fiber optics, including wires that comprise the bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 700. In various other embodiments of the present disclosure, a plurality of the computer systems 700 coupled by a communication link 724 to the network 510 (e.g., such as a LAN, WLAN, PTSN, and/or various other wired or wireless networks, including telecommunications, mobile, and cellular phone networks) may perform instruction sequences to practice the present disclosure in coordination with one another.

The computer system 700 may transmit and receive messages, data, information and instructions, including one or more programs (i.e., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

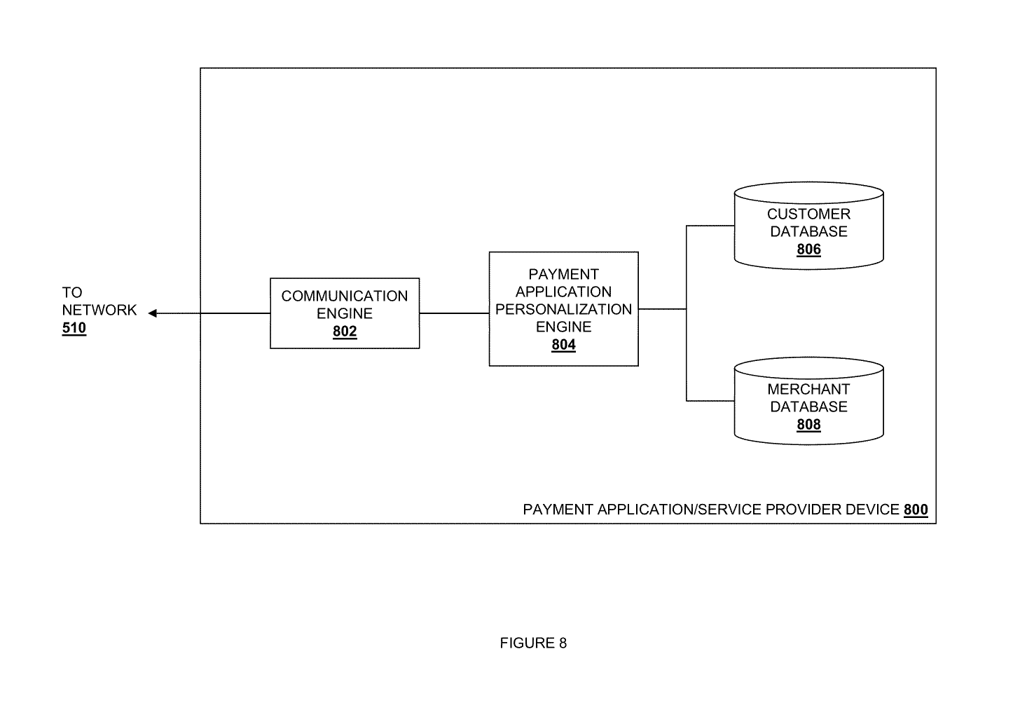

Referring now to FIG. 8, an embodiment of a payment application/service provider device 800 is illustrated. In an embodiment, the device 800 may be the payment service provider device 506 and/or the payment application provider device 509. The device 800 includes a communication engine 802 that is coupled to the network 510 and to a payment application personalization engine 804 that is coupled to a customer database 806 including customer information associated with a plurality of customers and a merchant database 808 including merchant information associated with a plurality of merchants. The communication engine 802 may be software or instructions stored on a computer-readable medium that allows the device 800 to send and receive information over the network 510. The payment application personalization engine 804 may be software or instructions stored on a computer-readable medium that is operable to receive merchant physical location personalization information from merchant device, store merchant physical location personalization information in the merchant database 808 in associated with merchants and merchant physical locations, receive customer locations from customer devices, determine merchant physical locations that are associated with customer locations, provide merchant physical location personalization information as user interfaces on a payment application on customer device, determine recommendations for products and services, perform payment activities between customers and merchants, and provide any of the other functionality that is discussed above. While the databases 806 and 808 has been illustrated as located in the device 800, one of skill in the art will recognize that it may be connected to the payment application personalization engine 804 through the network 510 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

1. A system, comprising:
a non-transitory memory storing respective merchant physical location personalization information and a respective merchant account for each of a plurality of merchant physical locations, and storing a respective customer account for each of a plurality of customers; and
one or more hardware processors coupled to the memory and configured to read instructions from the memory to perform the steps of:
receiving over a network from a first customer device of a first customer of the plurality of customers, a first customer location wherein the first customer device is providing a payment application;
determining a first merchant physical location that is within a predetermined distance of the first customer location and, in response, retrieving first merchant physical location personalization information for the first merchant physical location from the non-transitory memory;
using the first merchant physical location personalization information to provide over the network to the first customer device, at least one personalized merchant physical location screen on the payment application that is branded for the first merchant physical location, wherein the at least one personalized merchant physical location screen is configured to send an instruction to make a payment from a first customer account of the first customer that is stored in the non-transitory memory to a first merchant account of the first merchant physical location that is stored in the non-transitory memory.

2. The system of claim 1, wherein the one or more hardware processors are configured to read instructions from the memory to perform the steps of:
receiving over the network, the first merchant physical location personalization information from a first merchant device associated with the first merchant physical location.

3. The system of claim 1, wherein the one or more processors are configured to read instructions from the memory to perform the steps of:
receiving over the network, at least one command to access a payment application provider database to provide customer specific information on the at least one personalized merchant physical location screen.

4. The system of claim 3, wherein the one or more processors are configured to read instructions from the memory to perform the steps of:
retrieving customer specific information for the first customer from the payment application provider database; and
providing over the network for display on the first customer device, the customer specific information for the first customer on the at least one personalized merchant physical location screen.

5. The system of claim 1, wherein the first merchant physical location personalization information includes data describing a color scheme that is used in branding the at least one personalized merchant physical location screen for the first merchant physical location, wherein the data describing the color scheme is received by the payment application provider device from a first merchant device associated with the first merchant physical location in the non-transitory memory.

6. The system of claim 1, wherein the first merchant physical location personalization information includes a data describing a background and at least one image that are used in branding the at least one personalized merchant physical location screen for the first merchant physical location, wherein the data describing the background and the at least one image is received by the payment application provider device from a first merchant device associated with the first merchant physical location in the non-transitory memory and that is accessible by the payment application provider device over the network.

7. A method for providing a payment application personalized for a merchant physical location, comprising:
receiving, by a payment application provider device, a customer location over a network from a customer device that is running a payment application;
determining, by the payment application provider device, a merchant physical location that is co-located with the customer location and, in response, retrieving by the payment application provider device, merchant physical location personalization information for the merchant physical location;
using the merchant physical location personalization information to provide, by the payment application provider device over the network to the customer device, at least one personalized merchant physical location screen on the payment application that is branded for the merchant physical location, wherein the at least one personalized merchant physical location screen is configured to send an instruction to the payment application provider device to make a payment from a customer account that is linked with the customer device to a merchant account that is linked with the merchant physical location.

8. The method of claim 7, further comprising:
receiving, by the payment application provider device over the network, the merchant physical location personalization information from a merchant device associated with the merchant physical location.

9. The method of claim 7, further comprising:
receiving, by the payment application provider device over the network, instructions to access a payment application provider database to provide customer specific information on the at least one personalized merchant physical location screen.

10. The method of claim 9, further comprising:
retrieving, by the payment application provider device, customer specific information that is associated with the customer in a payment application provider database; and
providing, by the payment application provider device over the network for display on the customer device, the customer specific information for the customer on the at least one personalized merchant physical location screen.

11. The method of claim 7, wherein the merchant physical location personalization information includes data describing a color scheme that is used in branding the at least one personalized merchant physical location screen for the merchant physical location, wherein the data describing the color scheme is received by the payment application provider device from a merchant device associated with the merchant physical location.

12. The method of claim 7, wherein the merchant physical location personalization information includes data describing a background and at least one image that are used in branding the at least one personalized merchant physical location screen for the merchant physical location, wherein the data describing the background and the at least one image is received by the payment application provider device from a merchant device associated with the merchant physical location and that is accessible by the payment application provider device over the network.

13. The method of claim 7, further comprising:
receiving, by the payment application provider device over the network, instructions to access a merchant database to provide customer specific information on the at least one personalized merchant physical location screen;
retrieving, by the payment application provider device over the network, customer specific information that is associated with the customer in the merchant database; and
providing, by the payment application provider device over the network for display on the customer device, the customer specific information for the first customer on the at least one personalized merchant physical location screen.

14. A non-transitory machine-readable medium comprising a plurality of machine-readable instructions which, when executed by one or more processors, are adapted to cause the one or more processors to perform a method comprising:
receiving, by a payment application provider device, a customer location over a network from a customer device of a customer that is providing a payment application;
determining, by the payment application provider device, a merchant physical location that overlaps with the first customer location and, in response, retrieving, by the payment application provider device, merchant physical location personalization information for the first merchant physical location from a database;
using the first merchant physical location personalization information to provide, by the payment application provider device over the network to the customer device, at least one personalized merchant physical location screen on the payment application that is branded for the merchant physical location, wherein the at least one personalized merchant physical location screen is configured to send an instruction to the payment application provider device to make a payment from a customer account of the first customer to a first merchant account of the first merchant physical location.

15. The non-transitory machine-readable medium of claim 14, wherein the method further comprises:
receiving, by the payment application provider device over the network, the merchant physical location personalization information from a merchant device associated with the first merchant physical location.

16. The non-transitory machine-readable medium of claim 14, wherein the method further comprises:
receiving, by the payment application provider device over the network, instructions to access a payment application provider database to provide customer specific information on the at least one personalized merchant physical location screen.

17. The non-transitory machine-readable medium of claim 16, wherein the method further comprises:
retrieving, by the payment application provider device, customer specific information that is associated with the customer in a payment application provider database; and
providing, by the payment application provider device over the network for display on the customer device, the customer specific information for the customer on the at least one personalized merchant physical location screen.

18. The non-transitory machine-readable medium of claim 14, wherein the first merchant physical location personalization information includes data describing a color scheme that is used in branding the at least one personalized merchant physical location screen for the merchant physical location, wherein the data describing the color scheme is received by the payment application provider device from a merchant device associated with the first merchant physical location in the database.

19. The non-transitory machine-readable medium of claim 14, wherein the first merchant physical location personalization information includes data describing a background and at least one image that are used in branding the at least one personalized merchant physical location screen for the merchant physical location, wherein the data describing the background and the at least one image is received by the payment application provider device from a first merchant device associated with the first merchant physical location in the database and that is accessible by the payment application provider device over the network.

20. The non-transitory machine-readable medium of claim 14, wherein the method further comprises:
receiving, by the payment application provider device over the network, instructions to access a merchant database to provide customer specific information on the at least one personalized merchant physical location screen;
retrieving, by the payment application provider device over the network, customer specific information that is associated with the customer in the merchant database; and
providing, by the payment application provider device over the network for display on the customer device, the customer specific information for the customer on the at least one personalized merchant physical location screen.
